(19) United States
(12) Patent Application Publication
(10) Pub. No.: US 2013/0138316 A1
(43) Pub. Date: May 30, 2013

(54) Brake Control Apparatus

(71) Applicant: Kotaro KOYAMA, Isehara-shi (JP)

(72) Inventor: Kotaro KOYAMA, Isehara-shi (JP)

(73) Assignee: Hitachi Automotive Systems, Ltd., Hitachinaka-shi (JP)

(21) Appl. No.: 13/613,728

(22) Filed: Sep. 13, 2012

(30) Foreign Application Priority Data
Nov. 25, 2011 (JP) 2011-257242

(51) Int. Cl. B60T 8/17

(52) U.S. Cl. 701/70

(57) ABSTRACT

A brake control apparatus includes a parking-brake mechanism configured to apply braking force to left and right wheels of one of front and rear of a vehicle by a switching operation of a driver; a braking-force generating section configured to apply braking force independently to the wheels in accordance with a state of the vehicle; a moving-state judging section configured to judge whether or not the vehicle is moving; and a braking-force control unit configured to control the braking-force generating section. The braking-force control unit includes a braking-force cooperative control section configured to restrict an actuation of the parking-brake mechanism and to cause the braking-force generating section to generate braking force in a case that the parking-brake mechanism is required to be actuated by the switching operation when the moving-state judging section determines that the vehicle is moving.

### BACKGROUND OF THE INVENTION

The present invention relates to a brake control apparatus.

Japanese Patent No. 4360231 discloses a technique in which a parking-brake mechanism is actuated by a switching operation of a driver.

### SUMMARY OF THE INVENTION

However, in the above technique, when the driver actuates the parking-brake mechanism by the switching operation during a moving state of vehicle, there is a problem that braking forces of only specific wheels are increased so that a vehicle behavior becomes unstable.

It is therefore an object of the present invention to provide a brake control apparatus devised to suppress the unstable state of vehicle behavior when the parking-brake mechanism is required to be actuated during the moving state of vehicle.

According to one aspect of the present invention, there is provided a brake control apparatus comprising: a parking-brake mechanism configured to apply braking force to left and right wheels of one of front and rear of a vehicle by a switching operation of a driver; a braking-force generating section configured to apply braking force independently to the wheels in accordance with a state of the vehicle; a moving-state judging section configured to judge whether or not the vehicle is moving; and a braking-force control unit configured to control the braking-force generating section, the braking-force control unit including a braking-force cooperative control section configured to restrict an actuation of the parking-brake mechanism and to cause the braking-force generating section to generate braking force in a case that the parking-brake mechanism is required to be actuated by the switching operation when the moving-state judging section determines that the vehicle is moving.

According to another aspect of the present invention, there is provided a brake control apparatus comprising: an electric parking-brake mechanism configured to apply braking force to rear left and right wheels of a vehicle by a switching operation of a driver; a braking-force generating section configured to apply braking force independently to the wheels in accordance with a state of the vehicle; a moving-state judging section configured to judge whether or not the vehicle is in a moving state; an electric parking-brake control unit configured to control the electric parking-brake mechanism; and a braking-force control unit configured to control the braking-force generating section, wherein one of the electric parking-brake control unit and the braking-force control unit is configured to prohibit an actuation of the electric parking-brake mechanism in a case that the switching operation is conducted when the moving-state judging section determines that the vehicle is in the moving state.

According to still another aspect of the present invention, there is provided a brake control apparatus comprising: an electric parking-brake mechanism configured to apply braking force to rear left and right wheels of a vehicle by a switching manipulation of a driver; a braking-force generating section configured to apply braking force independently to the wheels in accordance with a state of the vehicle; a parking-brake-mechanism abnormal-state judging section configured to judge whether or not the electric parking-brake mechanism is in an abnormal state; a braking-force-generating-section abnormal-state judging section configured to judge whether or not the braking-force generating section is in an abnormal state; and a moving-state judging section configured to judge whether or not the vehicle is moving; wherein the electric parking-brake mechanism and the braking-force generating section are selectively actuated in accordance with judgment results of the parking-brake-mechanism abnormal-state judging section, the braking-force-generating-section abnormal-state judging section and the moving-state judging section at a time of the switching manipulation.

The other objects and features of this invention will become understood from the following description with reference to the accompanying drawings.

### BRIEF DESCRIPTION OF DRAWINGS

FIG. 1 is a system configuration view of a vehicle to which a brake control apparatus according to a first embodiment of the present invention is applied.

FIG. 2 is a circuit configuration diagram of a hydraulic unit 1.

FIG. 3 is a view showing sent/received signals between respective ECUs.

FIG. 4 is a flowchart showing a flow of a braking control processing of a hydraulic unit ECU 2.

FIG. 5 is a flowchart showing a flow of a calculation processing of desired braking force by an application program existing in the hydraulic unit ECU 2, which is performed at step S2 of FIG. 4.

FIG. 6 is a view showing an example in which desired braking force is raised in a stepwise manner to attain a predetermined deceleration level.

FIG. 7 is a view showing an example in which the desired braking force is raised at a predetermined gradient according to a vehicle speed and then is maintained when attaining a predetermined deceleration level.

FIG. 8 is an explanatory view of a selection processing from values desired by the other systems, which is performed at step S3 of FIG. 4.

FIG. 9 is a flowchart showing a flow of calculation processing of braking-force requests to the other systems, which is performed at step S5 of FIG. 4.

FIG. 10 is a flowchart showing a flow of calculation processing of an electric parking brake ECU.

FIG. 11 is a flowchart showing a flow of parking-brake control process, which is performed at step S62 of FIG. 10.

FIG. 12 is a flowchart showing a flow of control process of an electrically-controlled booster.

FIG. 13 is a flowchart showing a flow of calculation process of a driver-desired braking-force value, which is performed at step S82 of FIG. 12.

FIG. 14 is a flowchart showing a flow of desired braking-force calculation process which is performed at step S83 of FIG. 12.

FIG. 15 is a time chart showing an operation by the calculation of the desired braking-force value.

FIG. 16 is a view showing a stable region of vehicle behavior in the first embodiment.

### DETAILED DESCRIPTION OF THE INVENTION

Reference will hereinafter be made to the drawings in order to facilitate a better understanding of the present invention. Respective embodiments of brake control apparatus according to the present invention will be explained below in detail, referring to the drawings.

### First Embodiment

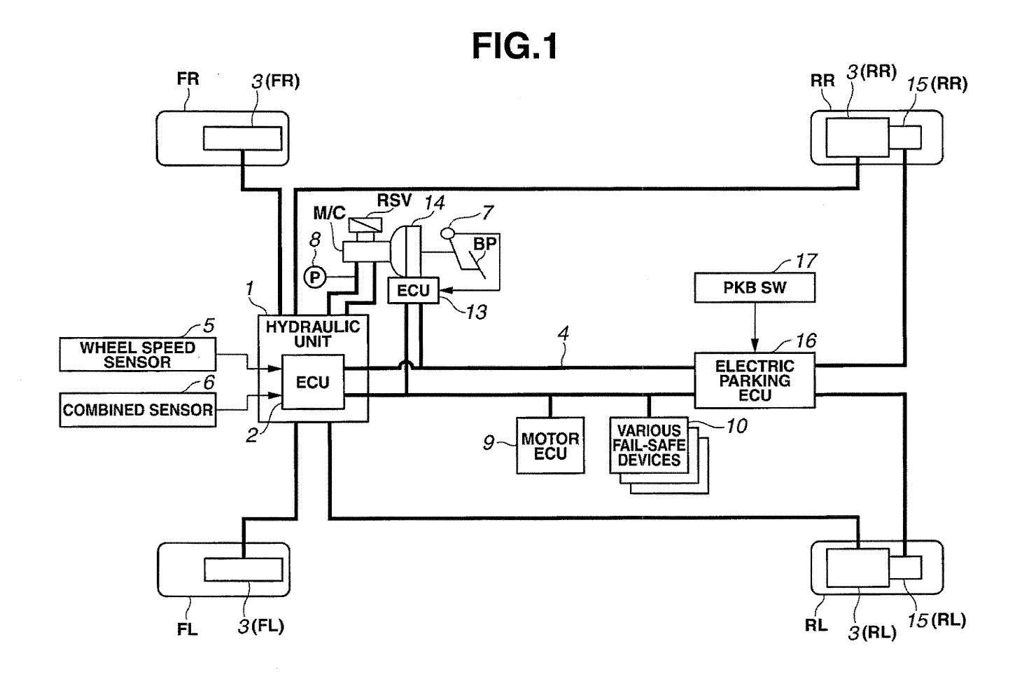

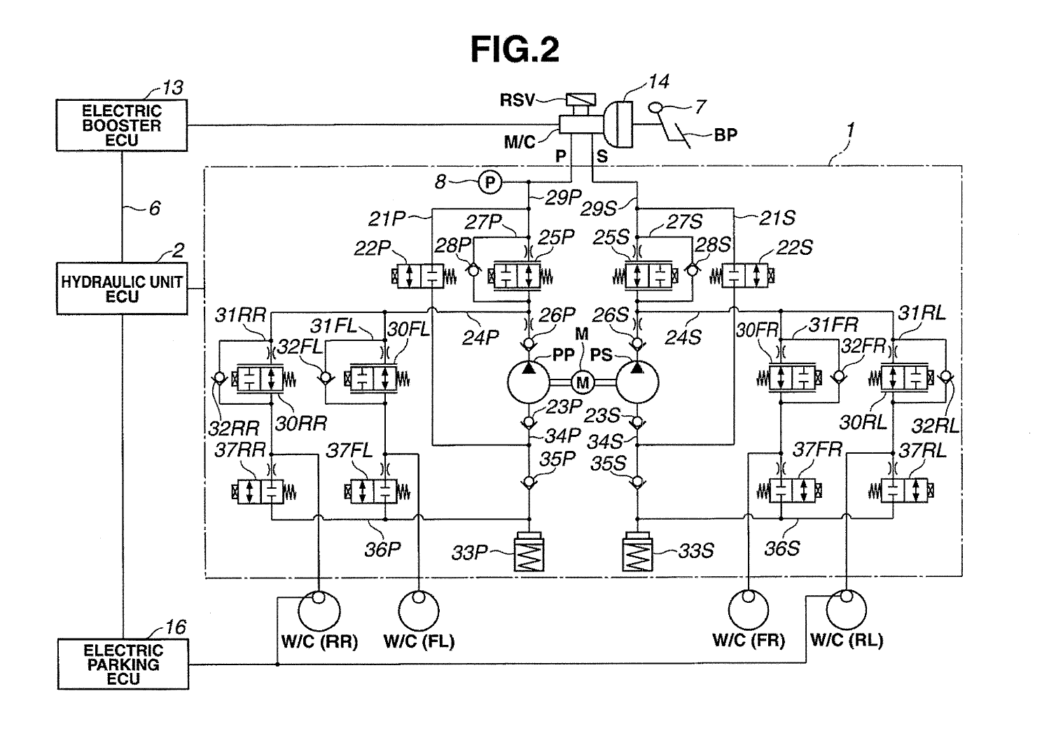

At first, a structure will now be explained. FIG. 1 is a system configuration view of a vehicle to which a brake control apparatus is applied according to a first embodiment of the present invention. FIG. 2 is a circuit configuration diagram of an oil hydraulic unit 1 according to the first embodiment.

[System Configuration]

The hydraulic unit 1 (braking-force generating section) functions to adjust hydraulic pressures of wheel cylinders W/C of respective wheels FL, FR, RL, RR in accordance with commands derived from a hydraulic unit ECU 2 (braking-force control unit or braking-force-generating-section control unit). Moreover, the hydraulic unit 1 controls actuations of brake calipers 3 (hereinafter, brake calipers of left and right front wheels FL and FR will be referred to as “front calipers”, and brake calipers of left and right rear wheels RL and RR will be referred to as “rear calipers”). The hydraulic unit ECU 2 directly receives respective wheel speeds sensed by wheel speed sensors 5, a lateral acceleration and a yaw rate of the vehicle which are sensed by a combined sensor 6, and a master-cylinder pressure sensed by a master-cylinder pressure sensor 8. The hydraulic unit ECU 2 communicates through a communication line 4 with a motor ECU 9, various fail-safe devices 10, an electric booster ECU 13, and an electric parking ECU 16 (parking-brake control unit or electric-parking-brake-mechanism control unit), by intercommunication. Transmission signals (sent/received signals) among the above-mentioned ECUs will be explained below. The motor ECU 9 operates power running or regenerative running of a motor/generator (not shown) for driving the left and right front wheels FL and FR, and thereby, applies driving force or regenerative braking force to the left and right front wheels FL and FR. The electric booster ECU 13 controls an electrically-controlled booster 14, and thereby, boosts a brake pedal stroke.

Left and right electric motors 15RL and 15RR are provided to left and right rear wheels RL and RR, and actuate left and right rear calipers 3RL and 3RR. The left and right rear calipers 3RL and 3RR cooperate with the left and right electric motors 15RL and 15RR to constitute an electric parking brake (parking-brake mechanism or electric parking-brake mechanism). The left and right electric motors 15RL and 15RR operate according to commands derived from the electric parking ECU 16. The electric parking ECU 16 actuates the electric parking brake in accordance with actuation requests derived from the hydraulic unit ECU 2.

[Circuit Configuration of Hydraulic Unit]

The hydraulic unit 1 in the first embodiment constructs a diagonal split layout of brake circuit having two pipe lines of a P-line (first pipe line) and an S-line (second pipe line), that is sometimes termed “X-split piping”. A suffix “P” added to reference signs of respective parts shown in FIG. 2 denotes the P-line, and a suffix “S” added to reference signs of respective parts shown in FIG. 2 denotes the S-line. Moreover, in FIG. 2, suffixes “FL”, “RR”, “FR” and “RL” denote relevancies respectively to the front left wheel, the rear right wheel, the front right wheel and the rear left wheel. In the following explanations, the suffixes “P”, “S”, “FL”, “RR”, “FR” and “RL” will be omitted in a case that the P-line and S-line are unnecessary to be discriminated from each other or in a case that the respective wheels are unnecessary to be discriminated from one another.

The hydraulic unit 1 in the first embodiment uses a “closed hydraulic circuit”. This term “closed hydraulic circuit” means a hydraulic circuit (oil-pressure circuit) which returns brake fluid supplied to the wheel cylinder W/C, through a master cylinder M/C to a reservoir tank RSV. For comparison, a term “open hydraulic circuit” means a hydraulic circuit which can return the brake fluid supplied to the wheel cylinder W/C, directly to the reservoir tank RSV, i.e., not through the master cylinder M/C.

The stroke of the brake pedal BP is sensed by a stroke sensor 7 and is inputted into the electric booster ECU 13. The electric booster ECU 13 boosts the brake pedal stroke by driving the electrically-controlled booster 14, and thereby, generates a brake fluid pressure (master-cylinder pressure) of the master cylinder M/C. The P-line is connected to the wheel cylinder W/C (FL) of the front left wheel FL and the wheel cylinder W/C (RR) of the rear right wheel RR. The S-line is connected to the wheel cylinder W/C (FR) of the front right wheel FR and the wheel cylinder W/C (RL) of the rear left wheel RL. Moreover, a pump PP is provided to the P-line, and a pump PS is provided to the S-line. For example, the pumps PP and PS are gear pumps, and are driven by one motor M.

The master cylinder M/C is connected through a pipe passage 21P or 21S with a suction side of each pump PP or PS (hereinafter collectively referred to as “pump P”). A gate in-valve 22 which is a normally-closed-type proportional electromagnetic valve is provided on each pipe passage 21, namely so as to cut across the pipe passage 21. The master-cylinder pressure sensor 8 for sensing the pressure of the master cylinder M/C is provided between the master cylinder M/C and the gate in-valve 22. A check valve 23 is provided on the pipe passage 21 between the gate in-valve 22 and the pump P. The check valve 23 is disposed to cut across the pipe passage 21. Each check valve 23 permits a flow of brake fluid in a direction toward the pump P from the gate in-valve 22, and prohibits a flow in the counter direction. A discharge side of each pump P is connected through a pipe passage 24 with the wheel cylinders W/C. A solenoid in-valve 30 which is a normally-open-type electromagnetic valve is provided on the pipe passage 24, namely so as to cut across the pipe passage 24. In detail, two solenoid in-valves 30FL and 30RR corresponding to the wheel cylinders W/C(FL) and W/C(RR) are disposed on the pipe passage 24P, and two solenoid in-valves 30FR and 30RL corresponding to the wheel cylinders W/C(FR) and W/C(RL) are disposed on the pipe passage 24S. A check valve 26 is provided on each pipe passage 24 between the solenoid in-valve 30 and the pump P. The check valve 26 is disposed to cut across the pipe passage 24. Each check valve 26 permits a flow of brake fluid in a direction toward the solenoid in-valve 30 from the pump P, and prohibits a flow in the counter direction. On the pipe passage 24, a pipe passage 31 is provided so as to make a detour around each solenoid in-valve 30. A check valve 32 is provided on the pipe passage 31, namely to cut across the pipe passage 31. Each check valve 32 permits a flow of brake fluid in a direction toward the pump P from the wheel cylinder W/C, and prohibits a flow in the counter direction.

The master cylinder M/C is connected through a pipe passage 29 with the pipe passage 24. The pipe passage 24 and the pipe passage 29 are merged with each other (connected with each other) at a point between the pump P and the solenoid in-valve 30. A gate out-valve 25 which is a normally-open-type proportional electromagnetic valve is provided on each pipe passage 29, namely so as to cut across each pipe passage 29. On the pipe passage 29, a pipe passage 27 is provided so as to make a detour around each gate out-valve 25. On the pipe passage 27, a check valve 28 is provided to cut across the pipe passage 27. Each check valve 28 permits a flow of brake fluid in a direction toward the wheel cylinder W/C from the master cylinder M/C, and prohibits a flow in the counter direction.

A reservoir 33 is provided on the suction side of the pump P and is connected through the pipe passage 34 with the pump P. A check valve 35 is provided between the reservoir 33 and the pump P. Each check valve 35 permits a flow of brake fluid in a direction toward the pump P from the reservoir 33, and prohibits a flow in the counter direction. The wheel cylinder W/C is connected through a pipe passage 36 with the pipe passage 34. The pipe passage 36 and the pipe passage 34 are merged (connected) with each other at a location between the check valve 35 and the reservoir 33. A solenoid out-valve 37 which is a normally-closed type electromagnetic valve is provided on each pipe passage 36, namely so as to cut across each pipe passage 36.

The hydraulic unit ECU 2 calculates control target values for an antilock brake control (ABS: Antilock Brake System) and a vehicle-behavior stabilization control on the basis of information derived from the respective sensors and ECUs or the like. Thereby, the hydraulic unit ECU 2 controls actuations of the electrically-controlled booster 14, the gate in-valve 22, the gate out-valve 25, the solenoid in-valve 30, the solenoid out-valve 37, and the motor M.

[Sent/Received Signals Between Respective ECUs]

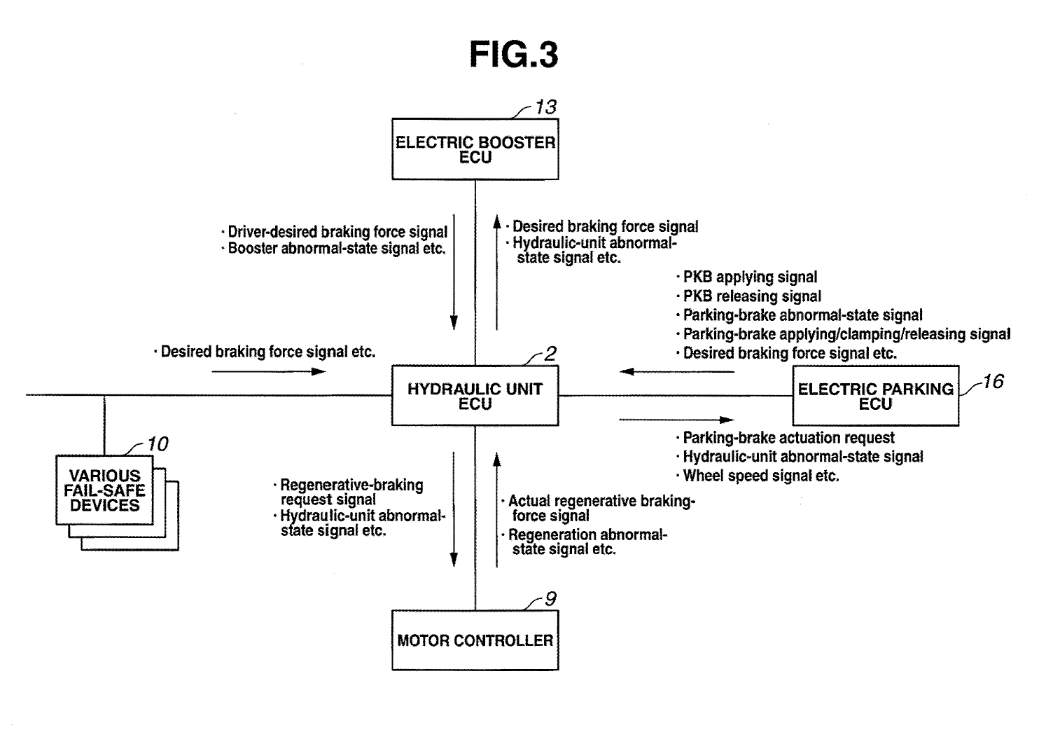

FIG. 3 is a view showing transmission signals (sent/received signals) between the respective ECUs. The motor controller 9 sends an actual regenerative braking-force signal and a regeneration abnormal-state signal of the motor/generator and the like, to the hydraulic unit ECU 2. The hydraulic unit ECU 2 sends a regenerative braking-request signal and a hydraulic-unit abnormal-state signal and the like, to the motor controller 9. The electric booster ECU 13 sends a driver-desired braking-force signal and a booster abnormal-state signal and the like, to the hydraulic unit ECU 2. The hydraulic unit ECU 2 sends a desired braking-force signal and a hydraulic-unit abnormal-state signal and the like, to the electric booster ECU 13. Each of the various fail-safe devices 10 sends a signal corresponding to desired braking force and the like, to the hydraulic unit ECU 2. The electric parking ECU 16 sends a parking-brake applying signal, a parking-brake releasing signal, an electric parking-brake abnormal-state signal, an electric parking-brake applying/clamping/releasing signal and a desired braking-force signal and the like, to the hydraulic unit ECU 2. The hydraulic unit ECU 2 sends an electric parking-brake actuation request, a hydraulic-unit abnormal-state signal and a wheel speed signal and the like, to the electric parking ECU 16.

[Braking Control Processing]

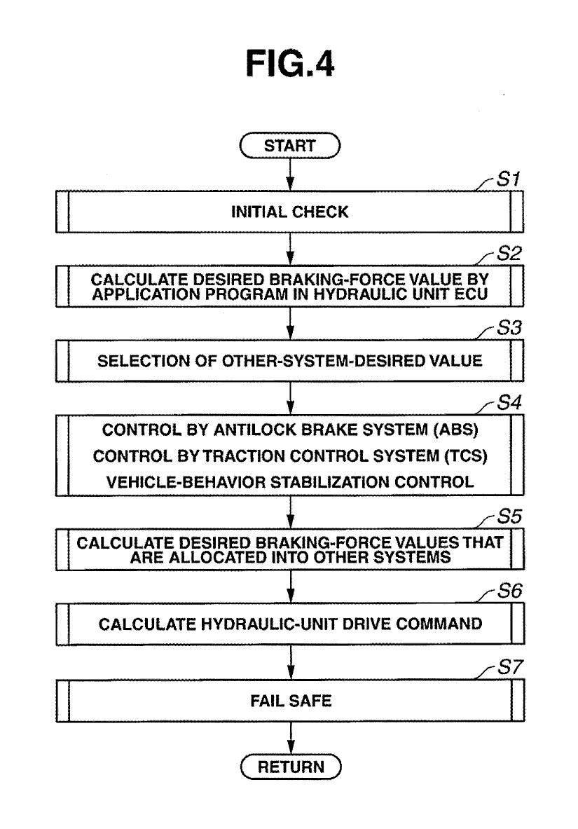

FIG. 4 is a flowchart showing a flow of a braking control processing of the hydraulic unit ECU 2. Respective steps of this flow will now be explained. From a timing when an ignition switch is turned on to a timing when the ignition switch is turned off, such a flow is repeated at a predetermined calculation intervals.

At step S1, the hydraulic unit ECU 2 performs an initial check process. That is, an initial diagnosis is performed when the ignition switch is turned on. At step S2, an application program executed in the hydraulic unit ECU 2 calculates a desired braking force. That is, each application program stored in the hydraulic unit ECU 2 outputs a desired braking-force value. At step S3, the hydraulic unit ECU 2 performs an other-system-desired-value selection. That is, a value of desired braking force which should be actually realized is selected from the value obtained at step S2, values calculated and desired by the other systems, a value desired by the driver and the like. At step S3, the request to actuate the electric parking brake is also checked. At step S4, the hydraulic unit ECU 2 performs processes of the antilock brake control (ABS), a traction control (TCS: Traction Control System) and the vehicle-behavior stabilization control. That is, if a slip of the road-wheel is generated or if a vehicle behavior becomes unstable when the above-mentioned desired braking force has been realized; the desired braking force is modified (i.e., varied). It is noted that the process of step S4 corresponds to a desired braking-force calculating section according to the present invention.

At step S5, the hydraulic unit ECU 2 performs an allocating calculation of the desired braking force into the other systems. That is, it is determined how the desired braking force is allocated (assigned) into the other systems in order to realize the desired braking force calculated as mentioned above. Thereby, braking-force requests for the other systems are computed. The other system means a system that can control the electrically-controlled booster 14 or the regenerative braking force of the motor/generator. It is noted that the process of step S5 corresponds to a braking-force cooperative control section according to the present invention. At step S6, the hydraulic unit ECU 2 performs a calculation of hydraulic-unit drive command. That is, valve drive commands and motor drive commands are computed from a command value obtained by the process of step S5 and the like. At step S7, the hydraulic unit ECU 2 performs a fail-safe check during the turn-on state of the ignition switch. If any failure is found, a predetermined treatment is carried out to prevent the vehicle from becoming in a dangerous state.

The process of each step will now be explained in detail.

[Calculation Processing of Desired Braking Force by Application Program Existing in Hydraulic Unit]

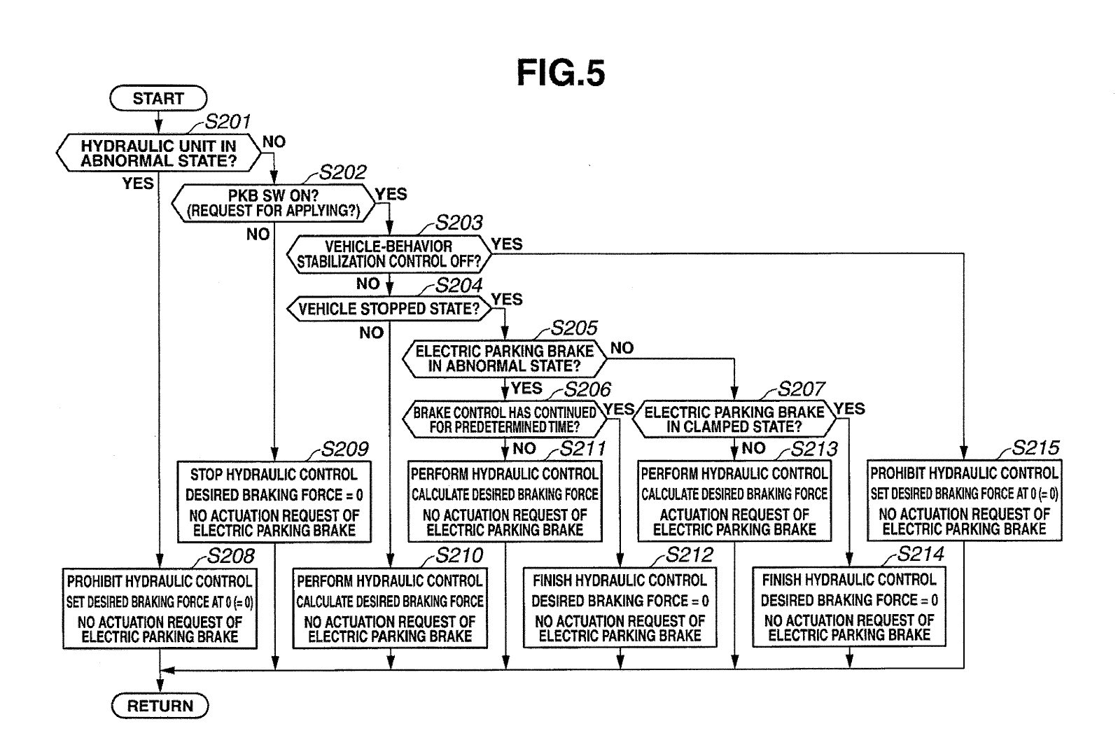

FIG. 5 is a flowchart showing a flow of the calculation processing of desired braking force by the application program existing in the hydraulic unit ECU 2, which is performed at step S2 of FIG. 4. At step S201, it is judged whether or not the hydraulic unit is in an abnormal state (failed state). If YES at step S201, the routine proceeds to step S208. If NO at step S201, the routine proceeds to step S202. At step S202, it is judged whether or not a parking brake switch 17 is in on-state (request for applying). If YES at step S202, the routine proceeds to step S203. If NO at step S202, the routine proceeds to step S209. At step S203, it is judged whether or not an OFF-switch of the vehicle-behavior stabilization control is in on-state (i.e., has been turned on). If YES at step S203, the routine proceeds to step S215. If NO at step S203, the routine proceeds to step S204. At step S204, it is judged whether or not the vehicle has stopped (i.e., the vehicle speed is equal to 0) on the basis of the wheel speeds derived from the respective wheel speed sensors 5. If YES at step S204, the routine proceeds to step S205. If NO at step S204, the routine proceeds to step S210. The process of step S204 corresponds to a moving-state judging section configured to judge whether or not the vehicle is moving. Alternatively, at this step S204, it may be judged whether or not a speed of the vehicle is lower than a predetermined low speed value because there is no risk that the vehicle behavior becomes unstable in a low-speed region.

At step S205, it is judged whether or not an electric parking brake is in an abnormal state (failed state) on the basis of presence/absence of the electric parking-brake abnormal-state signal. If YES at step S205, the routine proceeds to step S206. If NO at step S205, the routine proceeds to step S207. It is noted that the process of step S205 corresponds to a parking-brake-mechanism abnormal-state judging section according to the present invention. At step S206, it is judged whether or not a brake control has continued for a predetermined time duration. If YES at step S206, the routine proceeds to step S212. If NO at step S206, the routine proceeds to step S211. At step S207, it is judged whether or not the electric parking brake is in a clamped state. If YES at step S207, the routine proceeds to step S214. If NO at step S207, the routine proceeds to step S213. Alternatively, at step S207, it may be judged whether or not an output time of actuation request of the electric parking brake is longer than a predetermined time duration. This is because it can be determined that the electric parking brake is in the clamped state when the actuation request of the electric parking brake has continued for the predetermined time duration.

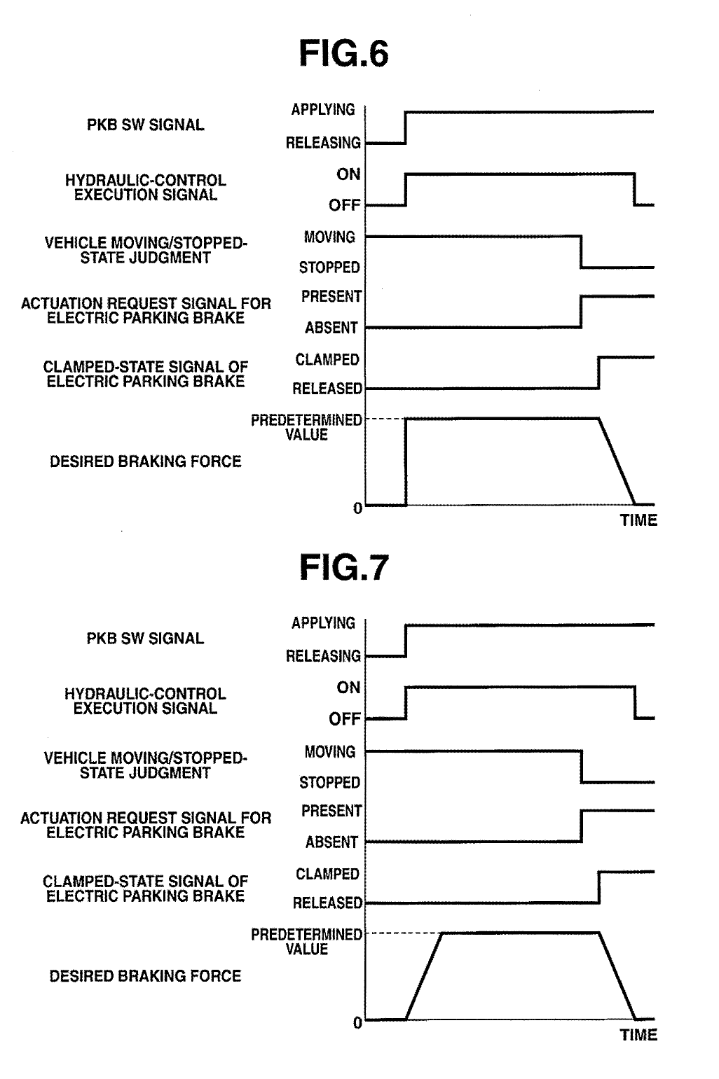

At step S208, a hydraulic control of the hydraulic unit 1 is prohibited, the desired braking force is set at 0, and the actuation request of the electric parking brake is cancelled (no request). At step S209, the hydraulic control of the hydraulic unit 1 is stopped, the desired braking force is set at 0, and the actuation request of the electric parking brake is cancelled (no request). At step S210, the hydraulic control of the hydraulic unit 1 is carried out, the desired braking force is calculated, and the actuation request of the electric parking brake is cancelled (no request). In this case, the desired braking force can be increased in a stepwise manner as shown in FIG. 6. Alternatively, the desired braking force can be increased at a predetermined gradient according to the vehicle speed and then be maintained when a predetermined deceleration is attained as shown in FIG. 7. Still alternatively, the desired braking force can be changed by receiving a desired braking-force command from the electric parking brake. As shown in FIGS. 6 and 7, a decreasing gradient of the desired braking force varies according to an inclination degree of a sloping road (hill) or the like. For example, the decreasing gradient of the desired braking force becomes smaller as the inclination degree of the sloping road becomes greater.

At step S211, the hydraulic control of the hydraulic unit 1 is carried out, the desired braking force is calculated, and the actuation request of the electric parking brake is cancelled (no request). At step S212, the hydraulic control of the hydraulic unit 1 is finished, the desired braking force is set at 0, and the actuation request of the electric parking brake is generated (request output). When finishing the hydraulic control of the hydraulic unit 1, the hydraulic control is reduced at a predetermined gradient in order to prevent the vehicle behavior from varying rapidly in a case that the vehicle stops on a sloping road. At step S213, the hydraulic control of the hydraulic unit 1 is carried out, the desired braking force is calculated, and the actuation request of the electric parking brake is generated (request output). At step S214, the hydraulic control of the hydraulic unit 1 is finished, the desired braking force is set at 0, and the actuation request of the electric parking brake is cancelled (no request). At step S215, the hydraulic control of the hydraulic unit 1 is prohibited, the desired braking force is set at 0, and the actuation request of the electric parking brake is cancelled (no request).

[Selection Processing of Other-System Desired Value]

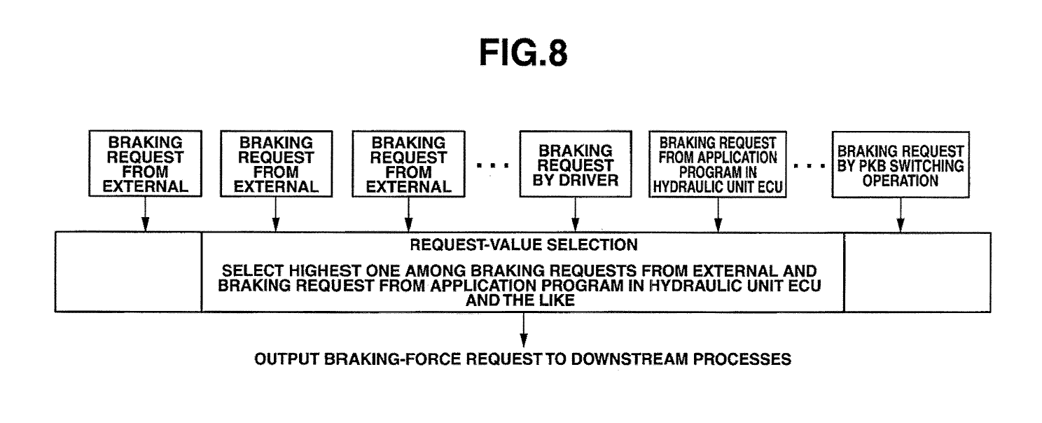

FIG. 8 is an explanatory view of the selection processing from the values desired by the other systems and the like, which is performed at step S3 of FIG. 4. In detail, the most appropriate value of the desired braking force for the vehicle (e.g., largest one) is selected from desired braking-force values derived from the other systems, desired braking-force value by a driver, and also desired braking-force value(s) derived from a function(s) existing in the hydraulic unit ECU 2. Such a function(s) is, for example, a brake assist function or a manipulation of the parking brake switch 17 under the moving state of the vehicle, each of which calculates its desired braking-force value in the hydraulic unit ECU 2.

[Processing of ABS, TCS and Vehicle-Behavior Stabilization Control]

The processing of the antilock brake control (ABS), the traction control (TCS) and the vehicle-behavior stabilization control which is performed at step S4 of FIG. 4 will now be explained. In the case that the wheel slip is caused when the above-mentioned (selected) desired braking-force value has been realized or in the case that the vehicle behavior becomes unstable when the above-mentioned desired braking-force value has been realized; the desired braking-force value is modified. For example, if a deceleration-side slip is caused, the desired braking-force value is modified to reduce actual braking force by way of the antilock brake control (ABS). Moreover, if the vehicle behavior has become unstable, the desired braking-force value is modified to generate a moment for stabilizing the vehicle behavior by way of the vehicle-behavior stabilization control. Moreover, if an acceleration-side slip is caused, the desired braking-force value is modified to increase the actual braking force by way of the traction control (TCS).

[Calculation Processing of Braking-Force Requests for Other Systems]

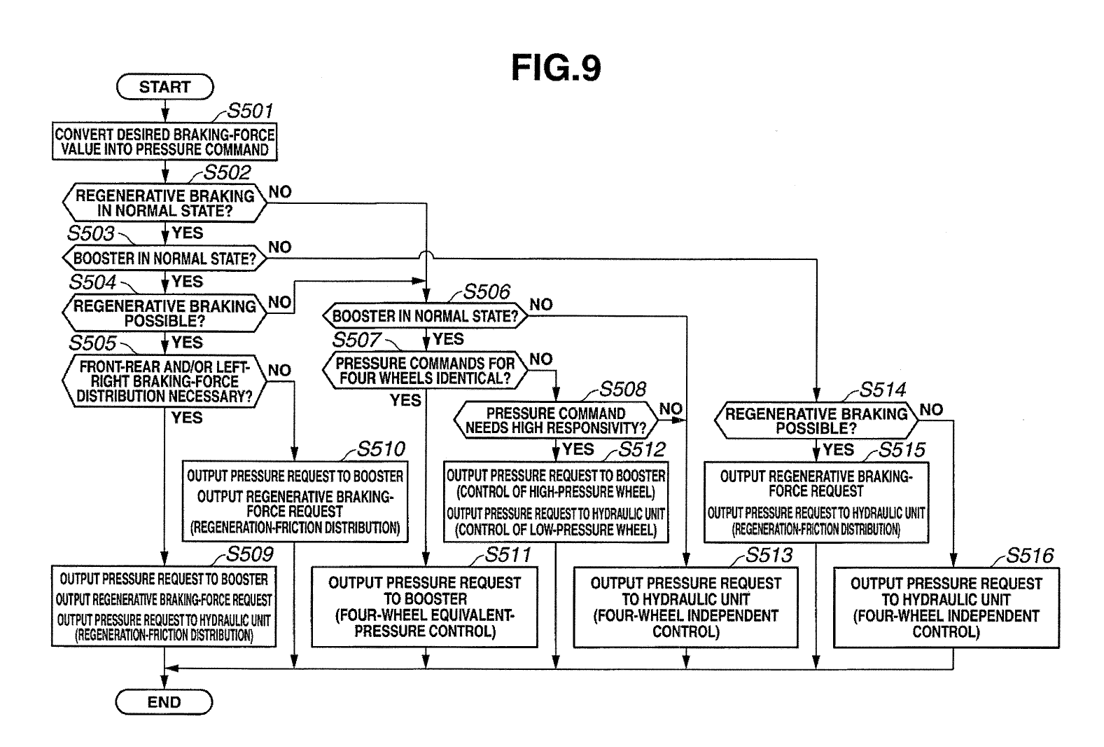

FIG. 9 is a flowchart showing a flow of the calculation processing of braking-force requests for the other systems, which is performed at step S5 of FIG. 4. At step S501, the desired braking-force value is converted into pressure commands. At step S502, it is judged whether or not a regenerative braking is in a normal state on the basis of presence/absence of the regeneration abnormal-state signal. If YES at step S502, the routine proceeds to step S503. If NO at step S502, the routine proceeds to step S506. At step S503, it is judged whether or not the electrically-controlled booster 14 is in a normal state on the basis of presence/absence of the booster abnormal-state signal. If YES at step S503, the routine proceeds to step S504. If NO at step S503, the routine proceeds to step S514. At step S504, it is judged whether or not the regenerative braking is possible. If YES at step S504, the routine proceeds to step S505. If NO at step S504, the routine proceeds to step S506. In this step S504, for example, it is determined that the regenerative braking is impossible in a case that the vehicle speed is in an extremely-low speed region or in a high speed region, or in a case that a battery is in a full-charged state. In the other cases, it is determined that the regenerative braking is possible. At step S505, it is judged whether or not front-rear and/or left-right braking-force distribution is necessary in consideration of the vehicle behavior and the like. If YES at step S505, the routine proceeds to step S509. If NO at step S505, the routine proceeds to step S510.

At step S506, it is judged whether or not the electrically-controlled booster 14 is in the normal state on the basis of presence/absence of the booster abnormal-state signal. If YES at step S506, the routine proceeds to step S507. If NO at step S506, the routine proceeds to step S513. At step S507, it is judged whether or not pressure commands for the four wheels are identical with each other. If YES at step S507, the routine proceeds to step S511. If NO at step S507, the routine proceeds to step S508.

At step S508, it is judged whether or not the pressure command needs a high responsivity. If YES at step S508, the routine proceeds to step S512. If NO at step S508, the routine proceeds to step S513. At step S509, a pressure request is outputted to the electrically-controlled booster 14, and a regenerative braking-force request is outputted to the motor controller 9 so that regenerative braking force is produced. Moreover, a pressure request is outputted to the hydraulic unit 1 so as to perform a distribution between regenerative braking force and friction braking force and so as to perform a distribution of the friction braking force between front and rear wheels and/or between left and right wheels. At step S510, a pressure request is outputted to the electrically-controlled booster 14, and a regenerative braking-force request is outputted to the motor controller 9 so that regenerative braking force is produced. At step S511, a pressure request is outputted to the electrically-controlled booster 14 so that the four wheels are controlled with an identical pressure level.

At step S512, a pressure request is outputted to the electrically-controlled booster 14 so that a high-pressure wheel(s) is controlled, and a pressure request is outputted to the hydraulic unit 1 so that a low-pressure wheel(s) is controlled. At step S513, a pressure request is outputted to the hydraulic unit 1 so that each of the four wheels is independently controlled. At step S514, it is judged whether or not the regenerative braking is possible. If YES at step S514, the routine proceeds to step S515. If NO at step S514, the routine proceeds to step S516.

At step S515, regenerative braking force is outputted, and a pressure request is outputted to the hydraulic unit 1 so as to perform a distribution between regenerative braking force and friction braking force. At step S516, a pressure request is outputted to the hydraulic unit 1 so that each of the four wheels is independently controlled.

[Calculation Processing of Electric Parking Brake ECU]

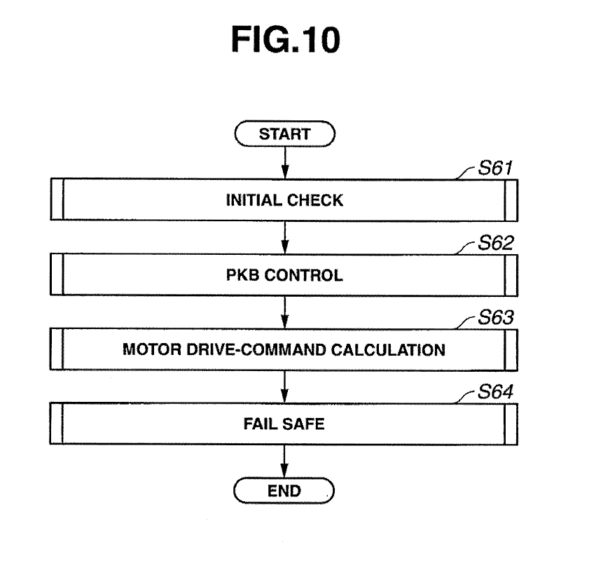

FIG. 10 is a flowchart showing a flow of calculation processing of the electric parking brake ECU. At step S61, an initial check process is performed. At step S62, a parking brake control process is performed. At this step S62, an actuation-end judgment for the parking brake is carried out, and a clamping/releasing process of the parking brake is carried out by a braking-force command for the parking brake. At step S63, a motor drive-command calculation process is performed. That is, the motor drive signal (command) is calculated according to desired braking force derived from the clamping/releasing process. At step S64, a fail-safe process is performed.

[Control Processing of Parking Brake]

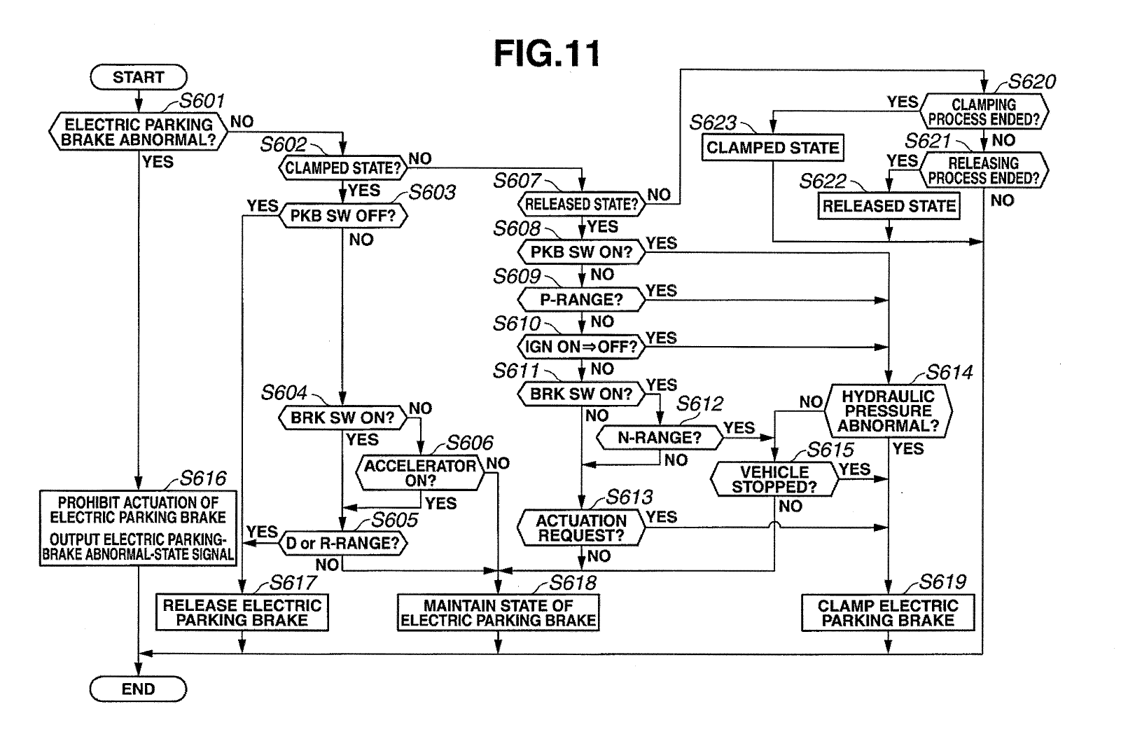

FIG. 11 is a flowchart showing a flow of the parking brake control process, which is performed at step S62 of FIG. 10. At step S601, it is judged whether or not the electric parking brake is in an abnormal state (failed state) on the basis of presence/absence of the electric parking-brake abnormal-state signal. If YES at step S601, the routine proceeds to step S616. If NO at step S601, the routine proceeds to step S602. At step S602, it is judged whether or not the parking brake is in the clamped state. If YES at step S602, the routine proceeds to step S603. If NO at step S602, the routine proceeds to step S607. At step S603, it is judged whether or not the parking brake switch 17 is in OFF state (i.e., has been turned off). If YES at step S603, the routine proceeds to step S617. If NO at step S603, the routine proceeds to step S604.

At step S604, it is judged whether or not a brake switch is in ON state (i.e., has been turned on). If YES at step S406, the routine proceeds to step S605. If NO at step S604, the routine proceeds to step S606. This brake switch is configured to become in ON state when a driver depresses the brake pedal BP, and to become in OFF state when the driver is not depressing the brake pedal BP. At step S605, it is judged whether or not a shift position is in D-range (Drive-position) or R-range (Reverse-position). That is, it is judged whether or not the D-range or the R-range has been selected as the shift position. If YES at step S605, the routine proceeds to step S617. If NO at step S605, the routine proceeds to step S618. At step S606, it is judged whether or not an accelerator is in ON state, namely, whether or not the driver is depressing an accelerator pedal. If YES at step S606, the routine proceeds to step S605. If NO at step S606, the routine proceeds to step S618.

At step S607, it is judged whether or not the parking brake is in a released state. If YES at step S607, the routine proceeds to step S608. If NO at step S607, the routine proceeds to step S620. At step S608, it is judged whether or not the parking brake switch 17 is in ON state (i.e., has been turned on). If YES at step S608, the routine proceeds to step S614. If NO at step S608, the routine proceeds to step S609. At step S609, it is judged whether or not the shift position is in P-range (Park-position). That is, it is judged whether or not the P-range has been selected as the shift position. If YES at step S609, the routine proceeds to step S614. If NO at step S609, the routine proceeds to step S610. At step S610, it is judged whether or not the ignition switch has been turned off, namely whether or not the ON state of the ignition switch has been changed to the OFF state thereof. If YES at step S610, the routine proceeds to step S614. If NO at step S610, the routine proceeds to step S611.

At step S611, it is judged whether or not the brake switch is in ON state. If YES at step S611, the routine proceeds to step S612. If NO at step S611, the routine proceeds to step S613. At step S612, it is judged whether or not the shift position is in N-range (Neutral-position). That is, it is judged whether or not the N-range has been selected as the shift position. If YES at step S612, the routine proceeds to step S615. If NO at step S612, the routine proceeds to step S613. At step S613, it is judged whether or not the actuation request of the parking brake is present. If YES at step S613, the routine proceeds to step S619. If NO at step S613, the routine proceeds to step S618.

At step S614, it is judged whether or not an abnormal state in hydraulic pressure has been caused. If YES at step S614, the routine proceeds to step S619. If NO at step S614, the routine proceeds to step S615. It is noted that this step S614 corresponds to a braking-force-generating-section abnormal-state judging section according to the present invention. At step S615, it is judged whether or not the vehicle is in a stopped state, namely, whether or not the vehicle has stopped. If YES at step S615, the routine proceeds to step S619. If NO at step S615, the routine proceeds to step S618. At step S616, the electric parking brake is prohibited from being actuated, and the electric parking-brake abnormal-state signal is outputted.

At step S617, a releasing process of the electric parking brake is performed. At step S618, the state of the electric parking brake is maintained. At step S619, a clamping process of the electric parking brake is performed. At step S620, it is judged whether or not the clamping process has ended. If YES at step S620, the routine proceeds to step S623. If NO at step S620, the routine proceeds to step S621. At step S621, it is judged whether or not the releasing process has ended. If YES at step S621, the routine proceeds to step S622. If NO at step S621, this calculation processing flow is ended. At step S622, the electric parking brake is made (regarded as) in the released state. At step S623, the electric parking brake is made (regarded as) in the clamped state.

[Control Processing of Electric Booster]

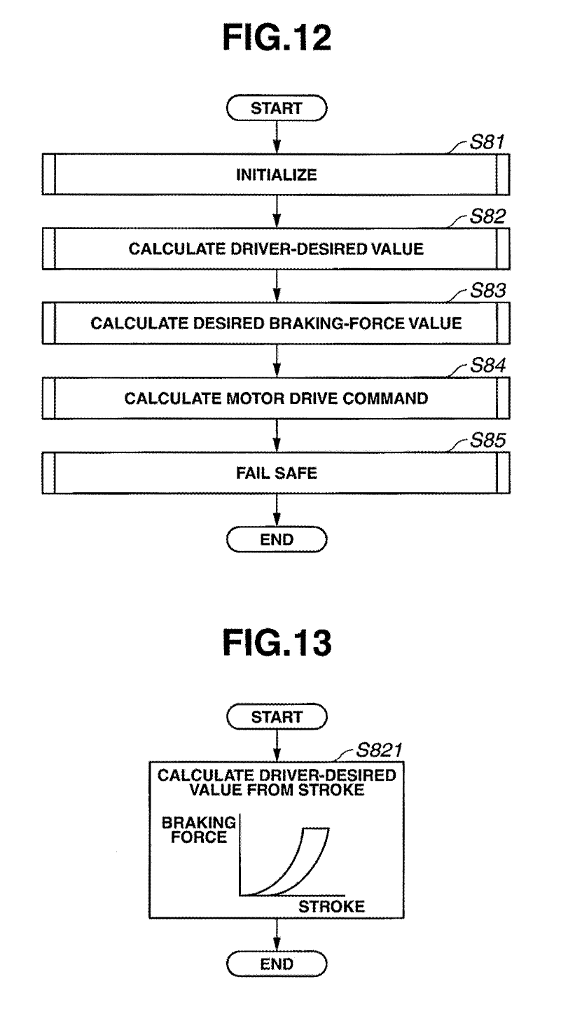

FIG. 12 is a flowchart showing a flow of the control process of the electrically-controlled booster. At step S81, an initializing process is performed. That is, an initial diagnosis is carried out when the ignition switch is turned on. At step S82, a driver-desired braking-force calculation process is performed. That is, a braking-force value desired by the driver is calculated from a brake pedal stroke or a depressing force (i.e., tread force) applied to the brake pedal BP. At step S83, a desired braking-force calculation process is performed. That is, a value of the desired braking force (which should be attained) is obtained by selecting one of the braking-force value desired by the driver and the braking-force values desired by the other ECUs. At step S84, a motor drive-command calculation process is performed. That is, a motor drive command is calculated which attains the selected desired braking force. At step S85, a fail-safe process is performed.

[Calculation Processing of Driver-Desired Braking Force]

FIG. 13 is a flowchart showing a flow of the calculation process of the driver-desired braking-force value, which is performed at step S82 of FIG. 12. At step S821, the braking-force value desired by the driver is calculated on the basis of the brake pedal stroke (amount), referring to a predetermined map. As shown by step S821 of FIG. 13, a characteristic between the brake pedal stroke and the driver-desired braking force is preset in a manner that the driver-desired braking force becomes larger as the stroke becomes larger. A hysteresis is provided to the map, in such a manner that values of the driver-desired braking force when the driver is depressing the brake pedal toward its maximum depressed position are larger than those when the driver is returning the brake pedal, with respect to stroke level.

[Calculation Process of Desired Braking Force]

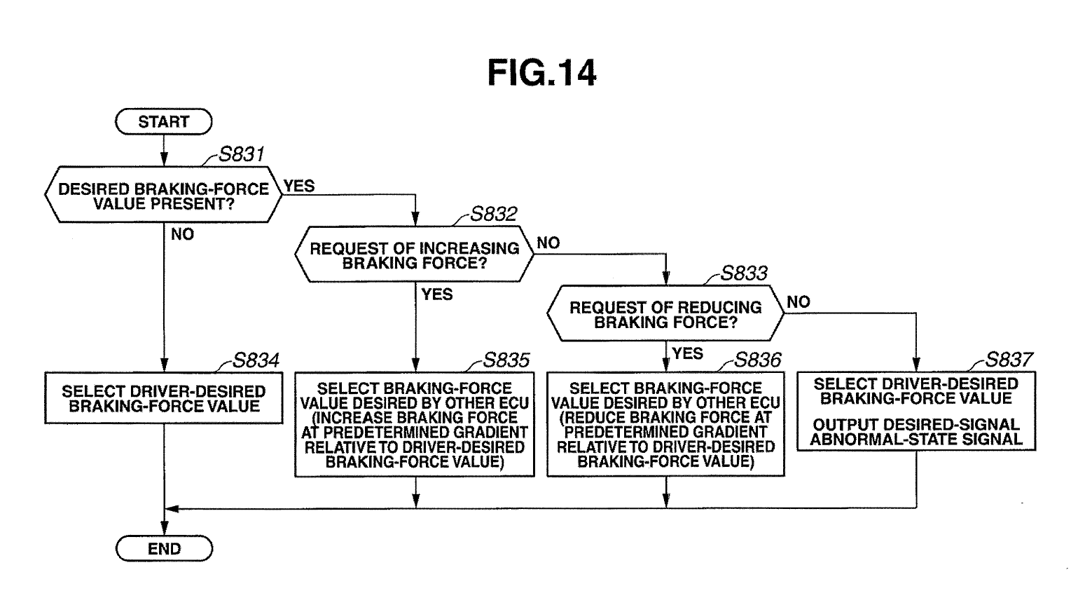

FIG. 14 is a flowchart showing a flow of the desired braking-force calculation process which is performed at step S83 of FIG. 12. At step S831, it is judged whether or not any desired braking-force value is required (present). If YES at step S831, the routine proceeds to step S834. If NO at step S831, the routine proceeds to step S832. At step S832, it is judged whether or not the (actual) braking force is required to be increased. If YES at step S832, the routine proceeds to step S835. If NO at step S832, the routine proceeds to step S833. At step S833, it is judged whether or not the braking force is required to be reduced. If YES at step S833, the routine proceeds to step S836. If NO at step S833, the routine proceeds to step S837.

At step S834, the braking-force value desired by the driver is selected. At step S835, the braking-force value desired by the other ECU is selected, so that the driver-desired braking-force value is increased at a predetermined gradient. At step S836, the braking-force value desired by the other ECU is selected, so that the driver-desired braking-force value is reduced at a predetermined gradient. At step S837, the driver-desired braking-force value is selected, so that a desired-signal abnormal-state signal is outputted.

Next, operations (functional flow) in the first embodiment according to the present invention will now be explained.

[Operations by Calculation of Desired Braking Force]

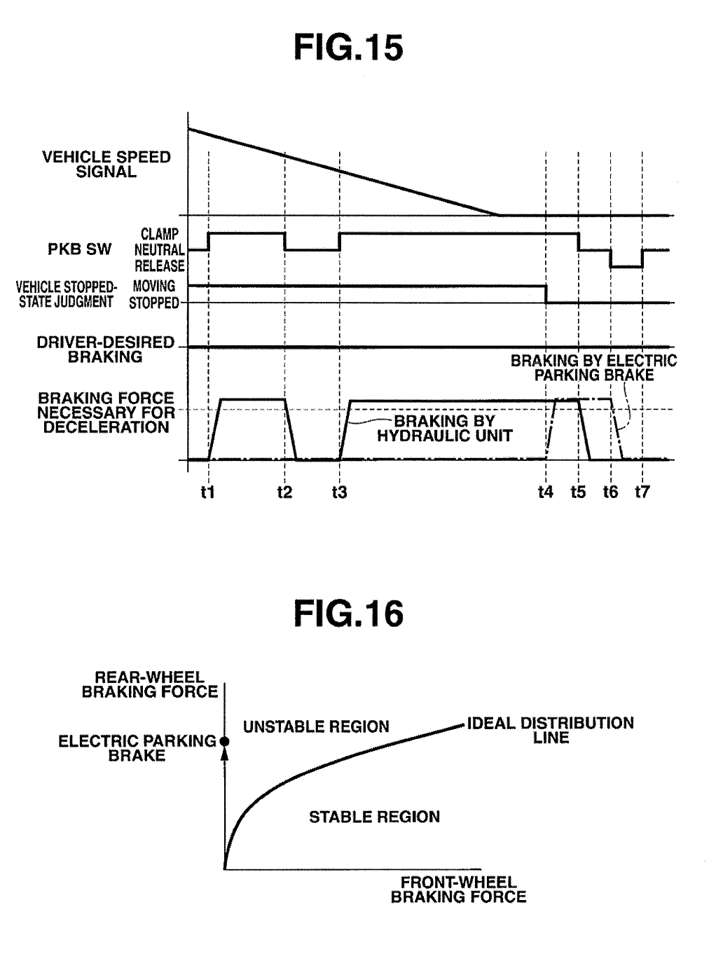

FIG. 15 is a time chart showing an operation by the calculation of the desired braking-force value.

At a time point t1, the parking brake switch 17 is manipulated and turned on. However, the electric parking brake is not actuated because it is determined that the vehicle is moving (running). At this time, a braking force necessary for deceleration (i.e., a braking-force level corresponding to the parking brake) is applied to the four wheels by an automatic braking of the hydraulic unit 1. (S201→S202→S204→S210 in FIG. 5) At this time, the actual braking force is increased at a predetermined gradient according to the vehicle speed.

At a time point t2, the parking brake switch 17 is returned to its neutral position. Hence, the braking force which is being generated by the hydraulic unit 1 is made to be equal to 0. (S201→S202→S209 in FIG. 5) At this time, the braking force is decreased at a predetermined gradient according to an inclination degree of the sloping road.

At a time point t3, the parking brake switch 17 is manipulated and turned on. However, the electric parking brake is not actuated because it is determined that the vehicle is moving (running). At this time, a braking force necessary for deceleration is applied to the four wheels by the automatic braking of the hydraulic unit 1. (S201→S202→S204→S210 in FIG. 5) At this time, the actual braking force is increased at a predetermined gradient according to the vehicle speed.

At a time point t4, it is determined that the vehicle has stopped. Hence, the left and right electric motors 15RL and 15RR are driven to actuate the electric parking brake. (S201→S202→S204→S205→S207→S213 in FIG. 5) At this time, the braking force which is being generated by the hydraulic unit 1 is maintained, and the actual braking force is increased at a predetermined gradient.

At a time point t5, the electric parking brake has become in the clamped state. Hence, the braking force which is being generated by the hydraulic unit 1 is made to be equal to 0. (S201→S202→S204→S205→S207→S214 in FIG. 5) At this time, the braking force is decreased at a predetermined gradient according to the inclination degree of the sloping road.

At a time point t6, the parking brake switch 17 is manipulated and turned off. Hence, the braking force which is being generated by the electric parking brake is made to be equal to 0. (S601→S602→S603→S617 in FIG. 11)

[Operations of Stabilization of Vehicle Behavior]

In the structure of a general parking brake, a wire of the parking brake provided to the rear wheels is pulled by the driver's manipulation, so that braking force is generated. Hence, if the driver manipulates the parking brake at the time of cornering (turning) of the vehicle, a large braking force is applied only to the rear wheels. Thus, a braking-force control is performed always in an unstable region shown in FIG. 16, and thereby, the vehicle becomes unstable. This phenomenon is noticeable in the case of a road surface whose friction coefficient μ is low, such as a snowy road surface and a black-ice road surface. An electric parking brake can apply and remove braking force to/from the rear wheels with no relation to the driver's manipulation. Moreover, hydraulic brake can be controlled to be automatically applied to the wheels from a viewpoint of safety.

Therefore, the structure according to the first embodiment of the present invention is focused on the fact that the vehicle behavior becomes unstable when the parking brake is manipulated at the time of cornering, and the fact that the electric parking brake can apply and remove braking force to/from the rear wheels without relation to the driver's manipulation. That is, in the case that the parking brake is manipulated during the moving (running) of the vehicle, the hydraulic unit 1 applies hydraulic braking force to the four wheels. Since the hydraulic brake can independently control the braking forces of the four wheels, the vehicle behavior can be controlled always in a stable region shown in FIG. 16. Accordingly, the vehicle behavior can be inhibited from becoming unstable so that the stability of the vehicle is ensured, while securing the braking force desired by the driver.

Moreover, since the braking control of the hydraulic unit 1 is used instead of the electric parking brake in the first embodiment, the antilock brake control (ABS), the traction control (TCS) and the vehicle-behavior stabilization control and the like are executable. Hence, the structure according to the first embodiment is advantageous in various scenes (situations) as compared with the case where only the electric parking brake is actuated. For example, if a wheel slip has occurred, the execution of automatic brake of the antilock brake control (ABS) is more advantageous than the usage of the electric parking brake having a low responsivity, also from a viewpoint of stabilizing the vehicle behavior. Moreover, even if the vehicle behavior comes near to become unstable (comes near to be disturbed), a braking-force distribution of the vehicle-behavior stabilization control can be conducted so that the vehicle behavior remains stable.

In the first embodiment, when it is determined that the vehicle has stopped; the braking force generated by the hydraulic unit 1 is reduced, and the electric parking brake is permitted to be actuated. In a case that the four-wheel braking of the hydraulic unit 1 continues also during the stopped state of the vehicle, the four solenoid in-valves 30 need to remain in closed state. Hence, an electric-power consumption from the battery is large. Contrary to this, in this embodiment, the electric parking brake is activated to activate the rear calipers 3RL and 3RR only by driving the two electric motors 15RL and 15RR. Accordingly, the electric-power consumption can be suppressed as compared with the case where the hydraulic unit 1 continues to be actuated also during the stopped state of the vehicle.

In this regard, the braking force which is being generated by the hydraulic unit 1 is reduced after the electric parking brake is actuated. For comparison, in a case that the braking force which is being generated by the hydraulic unit 1 is reduced before the electric parking brake is actuated, there is a risk that the vehicle moves downwardly on the sloping road during the stopped state of the vehicle. Therefore, in the first embodiment, the braking force of the hydraulic unit 1 is reduced, after the electric parking brake is actuated and then the vehicle has become in a state where the stopped state of the vehicle can be maintained. Hence, the vehicle stopped on the sloping road can be prevented from starting moving unintentionally in a downward direction of the sloping road.

Moreover, in the first embodiment, the decreasing gradient of braking force of the hydraulic unit 1 is set at a smaller value as the inclination degree of the sloping road becomes larger. Accordingly, the downward movement of the vehicle can be avoided more reliably when the vehicle is in the stopped state on the sloping road, even if an initial rise of braking force of the electric parking brake is retarded.

Moreover, in the first embodiment, when it is determined that the vehicle has become in the stopped state under the case where it has been determined that the electric parking brake is in the abnormal state; the desired braking-force value is calculated to maintain the braking force of the hydraulic unit 1 for the predetermined time duration (S201→S202→S204→S205→S206→S211 in FIG. 5). Then, when the predetermined time duration has elapsed, the desired braking-force value (the braking force of the hydraulic unit 1) is reduced, and the restriction of the actuation of the electric parking brake is continued (S201→S202→S204→S205→S206→S212 in FIG. 5). That is, when the desired braking-force value is reduced and the electric parking brake is activated immediately after the vehicle has stopped on the sloping road in the case that the electric parking brake has some trouble, there is a risk that a braking force necessary to maintain the stopped state of the vehicle cannot be secured so that the downward movement of the vehicle is caused. In this embodiment, by retaining the braking force of the hydraulic unit 1 for the predetermined time duration measured from vehicle-stop timing, the driver can have a time enough to depress the brake pedal BP. Therefore, the downward movement of the vehicle can be suppressed when the vehicle is stopping on the sloping road.

Moreover, in the first embodiment, when the actuation of the electric parking brake is required by the turn-on operation of the parking brake switch 17 during the moving state of the vehicle in a case where it has been determined that the hydraulic unit 1 is in the abnormal state, the electric parking-brake mechanism is permitted to be actuated (S601→S602→S607→S608→S614→S619 in FIG. 11). That is, in the case that the hydraulic unit 1 has some trouble, the actuation of the electric parking brake is permitted even if the vehicle is moving. Accordingly, the vehicle can be decelerated.

In the first embodiment, the hydraulic unit ECU 2 carries out the actuation judgment of the electric parking brake and outputs an actuation request to the electric parking ECU 16. Whereas the electric parking ECU 16 monitors only the state of the parking brake switch 17, the hydraulic unit ECU 2 constantly monitors the state of the vehicle by directly receiving signals of the sensors such as the wheel speed sensors 5 and the combined sensor 6. In this embodiment, since the hydraulic unit ECU 2 carries out the actuation judgment of the electric parking brake, a precise judgment can be conducted in conformity with the state of the vehicle.

### Other Embodiments

Although the invention has been described above with reference to certain embodiments of the invention, the invention is not limited to the embodiments described above. Modifications and variations of the embodiments described above will occur to those skilled in the art in light of the above teachings.

For example, in the above first embodiment, the actuation of the parking brake mechanism (3RL, 3RR, 15RL, 15RR) is prohibited in a case that the parking brake mechanism (3RL, 3RR, 15RL, 15RR) is required to be actuated by the switching operation when the moving-state judging section (S204) determines that the vehicle is moving. However, according to the present invention, in this case, the actuation of the parking brake mechanism (3RL, 3RR, 15RL, 15RR) may be restricted (limited).

For example, in the above first embodiment, the electric-motor vehicle has been exemplified. However, even if the brake control apparatus according to the present invention is applied to a hybrid vehicle or an engine vehicle, operations and advantageous effects similar to the above first embodiment can be obtained.

Next, configurations and advantageous effects in the brake control apparatus according to the embodiments of the present invention will now be listed and explained.

\textcircled{1} A brake control apparatus includes an electric parking brake (e.g., 3RL, 3RR, 15RL, 15RR in the drawings) configured to apply braking force to rear wheels (RL, RR) of a vehicle by a switching operation of a driver; a hydraulic unit (1) configured to apply braking force independently to four wheels (FL, FR, RL, RR) in accordance with a state of the vehicle; a moving-state judging section (S204) configured to judge whether or not the vehicle is moving; and a hydraulic unit ECU (2) configured to control the hydraulic unit (1). The hydraulic unit ECU (2) includes a braking-force cooperative control section (S5) configured to prohibit an actuation of the electric parking brake (3RL, 3RR, 15RL, 15RR) and to cause the hydraulic unit (1) to generate braking force in a case that the electric parking brake (3RL, 3RR, 15RL, 15RR) is required to be actuated by the switching operation when the moving-state judging section (S204) determines that the vehicle is moving. Accordingly, a braking-force level desired by the driver is secured, while the unstable state of vehicle behavior can be suppressed to ensure the stability of the vehicle.

\textcircled{2} The hydraulic unit ECU (2) further includes a desired braking-force calculating section (S4) configured to calculate a desired braking-force value which should be generated by the hydraulic unit (1) on the basis of a vehicle behavior, and the braking-force cooperative control section (S5) is configured to actuate the hydraulic unit (1) on the basis of the calculated desired braking-force value. Accordingly, the unstable state of the vehicle behavior can be suppressed more reliably.

\textcircled{3} The brake control apparatus further includes an electric parking ECU (e.g., 16 in the drawings) configured to control the electric parking brake (3RL, 3RR, 15RL, 15RR). The hydraulic unit ECU (2) further includes a desired braking-force calculating section (S4) configured to calculate a desired braking-force value which should be generated by the hydraulic unit (1). The hydraulic unit ECU (2) is configured to reduce the desired braking-force value such that the braking force of the hydraulic unit (1) is reduced, and to permit the electric parking ECU (16) to actuate the electric parking brake (3RL, 3RR, 15RL, 15RR), when it is determined that the vehicle state has changed from a moving state to a stopped state. Accordingly, electric-power consumption can be suppressed as compared with a case that the stopped state of the vehicle is maintained only by the braking force of the hydraulic unit (1).

\textcircled{4} The hydraulic unit ECU (2) is configured to reduce the braking force of the hydraulic unit (1) after actuating the electric parking brake (3RL, 3RR, 15RL, 15RR). Accordingly, an unintentional downward movement of the vehicle can be avoided when the vehicle has stopped on a sloping road.

\textcircled{5} The hydraulic unit ECU (2) is configured to reduce the braking force of the hydraulic unit (1) at a predetermined gradient. Accordingly, an unintentional downward movement of the vehicle can be avoided more reliably when the vehicle has stopped on a sloping road.

\textcircled{6} The brake control apparatus as described in the item \textcircled{1}, wherein the brake control apparatus further includes a parking-brake-mechanism abnormal-state judging section (S205) configured to judge whether or not the parking-brake mechanism (electric parking brake, e.g., 3RL, 3RR, 15RL, 15RR in the drawings) is in an abnormal state, and wherein the braking-force control unit (hydraulic unit ECU 2) is configured to continue to restrict the actuation of the parking-brake mechanism (3RL, 3RR, 15RL, 15RR) and to calculate a desired braking-force value such that the braking force of the braking-force generating section (hydraulic unit 1) is maintained for a predetermined time duration and then is reduced when the predetermined time duration has elapsed, in a case that the moving-state judging section (S204) determines that the vehicle state has changed from a moving state to a stopped state when the parking-brake-mechanism abnormal-state judging section (S205) has determined that the parking-brake mechanism (3RL, 3RR, 15RL, 15RR) is in the abnormal state.

In the case that the electric parking brake is in the abnormal state, when the desired braking force is reduced and the parking brake is actuated immediately after the vehicle stops on a sloping road, there is a risk that a braking force necessary to maintain the stopped state of the vehicle cannot be obtained so that the downward movement of the vehicle is caused. In the embodiment according to the present invention, by holding the braking force of the braking-force generating section (1) for the predetermined time duration measured from a vehicle stop timing, the driver can have a time enough to depress a brake pedal. Therefore, the unintentional downward movement of vehicle can be suppressed when the vehicle is in the stopped state on the sloping road.

\textcircled{7} The brake control apparatus as described in the item \textcircled{1}, wherein the brake control apparatus further includes a parking-brake control unit (16) configured to control the parking-brake mechanism (3RL, 3RR, 15RL, 15RR), and a braking-force-generating-section abnormal-state judging section (S614) configured to judge whether or not the braking-force generating section (1) is in an abnormal state, wherein the braking-force control unit (2) is configured to restrict an actuation of the braking-force generating section (1) when the braking-force-generating-section abnormal-state judging section (S614) determines that the braking-force generating section (1) is in the abnormal state, and wherein the parking-brake control unit (16) is configured to permit the actuation of the parking-brake mechanism (3RL, 3RR, 15RL, 15RR), when the parking-brake mechanism (3RL, 3RR, 15RL, 15RR) is required to be actuated by the switching operation in a case that the braking-force-generating-section abnormal-state judging section (S614) determines that braking-force generating section (1) is in the abnormal state and that the moving-state judging section (S204) determines that the vehicle is moving. Accordingly, in the case that the braking-force generating section (1) is in the abnormal state, the actuation of the parking-brake mechanism is allowed even under the moving state of vehicle. Therefore, the vehicle can be decelerated.

\textcircled{8} A brake control apparatus includes an electric parking-brake mechanism (e.g., 3RL, 3RR, 15RL, 15RR in the drawings) configured to apply braking force to wheels of a vehicle by a switching operation of a driver; a braking-force generating section (1) configured to apply braking force independently to the wheels in accordance with a state of the vehicle; a moving-state judging section (S204) configured to judge whether or not the vehicle is in a moving state; an electric parking-brake control unit (16) configured to control the electric parking-brake mechanism (3RL, 3RR, 15RL, 15RR); and a braking-force control unit (2) configured to control the braking-force generating section (1), wherein one of the electric parking-brake control unit (16) and the braking-force control unit (2) is configured to prohibit an actuation of the electric parking-brake mechanism (3RL, 3RR, 15RL, 15RR) in a case that the switching operation is conducted when the moving-state judging section (S204) determines that the vehicle is in the moving state. Accordingly, the vehicle behavior can be prevented from becoming unstable since the electric parking-brake mechanism is activated during the moving state of the vehicle.

\textcircled{9} The brake control apparatus as described in the item \textcircled{8}, wherein the one of the electric parking-brake control unit (16) and the braking-force control unit (2) is the braking-force control unit (2). Since the braking-force control unit (2) provided for controlling the braking-force generating section (1) constantly monitors or checks conditions of the vehicle, this braking-force control unit (2) can perform a proper judgment in dependence upon the conditions of the vehicle, as compared with the electric parking-brake control unit (16) which monitors only the state of switching operation.

\textcircled{10} The brake control apparatus as described in the item \textcircled{9}, wherein the braking-force control unit (2) includes a desired braking-force calculating section (S4) configured to calculate a desired braking-force value which should be generated by the braking-force generating section (1) on the basis of a vehicle behavior, and wherein the braking-force control unit (2) is configured to actuate the braking-force generating section (1) on the basis of the calculated desired braking-force value. Accordingly, a disordered state of the vehicle behavior can be suppressed more reliably.

\textcircled{11} The brake control apparatus as described in the item \textcircled{10}, wherein the braking-force control unit (2) is configured to reduce the desired braking-force value such that the braking force of the braking-force generating section (1) is reduced, and to permit the electric parking-brake control unit (16) to actuate the electric parking-brake mechanism (3RL, 3RR, 15RL, 15RR), when it is determined that the vehicle state has changed from the moving state to the stopped state. Accordingly, electric-power consumption can be suppressed as compared with the case where the stopped state of vehicle is maintained only by the braking force of the braking-force generating section (1).

\textcircled{12} The brake control apparatus as described in the item \textcircled{11}, wherein the braking-force control unit (2) is configured to reduce the braking force of the braking-force generating section (1) at a predetermined gradient after actuating the electric parking-brake mechanism (3RL, 3RR, 15RL, 15RR). Accordingly, the unintentional downward movement of the vehicle can be prevented when the vehicle stops on a sloping road.

\textcircled{13} The brake control apparatus as described in the item \textcircled{12}, wherein the brake control apparatus further includes a parking-brake-mechanism abnormal-state judging section (S205) configured to judge whether or not the electric parking-brake mechanism (3RL, 3RR, 15RL, 15RR) is in an abnormal state, and wherein the braking-force control unit (2) is configured to continue to restrict the actuation of the electric parking-brake mechanism (3RL, 3RR, 15RL, 15RR) and to calculate the desired braking-force value such that the braking force of the braking-force generating section (1) is maintained for a predetermined time duration and then is reduced when the predetermined time duration has elapsed, in a case that the moving-state judging section (S204) determines that the vehicle state has changed from the moving state to the stopped state when the parking-brake-mechanism abnormal-state judging section (S205) has determined that the electric parking-brake mechanism (3RL, 3RR, 15RL, 15RR) is in the abnormal state. Accordingly, the driver can afford to depress the brake pedal, so that the downward shift of the vehicle can be suppressed when the vehicle has stopped on the sloping road.

\textcircled{14} The brake control apparatus as described in the item \textcircled{13}, wherein the brake control apparatus further includes a braking-force-generating-section abnormal-state judging section (S614) configured to judge whether or not the braking-force generating section (1) is in an abnormal state, wherein the braking-force control unit (2) is configured to restrict the actuation of the braking-force generating section (1) when the braking-force-generating-section abnormal-state judging section (S614) determines that the braking-force generating section (1) is in the abnormal state, and wherein the parking-brake control unit (16) is configured to permit the actuation of the electric parking-brake mechanism (3RL, 3RR, 15RL, 15RR), when the electric parking-brake mechanism (3RL, 3RR, 15RL, 15RR) is required to be actuated by the switching operation in a case that the braking-force-generating-section abnormal-state judging section (S614) determines that braking-force generating section (1) is in the abnormal state and that the moving-state judging section (S204) determines that the vehicle is in the moving state. Accordingly, in the case that the braking-force generating section has some trouble, the vehicle speed can be decreased by permitting the actuation of the electric parking-brake mechanism (3RL, 3RR, 15RL, 15RR) even when the vehicle is moving (travelling).

\textcircled{15} A brake control apparatus includes an electric parking-brake mechanism (e.g., 3RL, 3RR, 15RL, 15RR in the drawings) configured to apply braking force to rear left and right wheels (RL and RR) of a vehicle by a switching manipulation of a driver; a braking-force generating section (1) configured to apply braking force independently to the wheels in accordance with a state of the vehicle; a parking-brake-mechanism abnormal-state judging section (S205) configured to judge whether or not the electric parking-brake mechanism (3RL, 3RR, 15RL, 15RR) is in an abnormal state; a braking-force-generating-section abnormal-state judging section (S614) configured to judge whether or not the braking-force generating section (1) is in an abnormal state; and a moving-state judging section (S204) configured to judge whether or not the vehicle is moving; wherein the electric parking-brake mechanism (3RL, 3RR, 15RL, 15RR) and the braking-force generating section (1) are selectively actuated in accordance with judgment results of the parking-brake-mechanism abnormal-state judging section (S205), the braking-force-generating-section abnormal-state judging section (S614) and the moving-state judging section (S204) at a time of the switching manipulation. Accordingly, a device to be actuated is freely selected from the electric parking-brake mechanism (3RL, 3RR, 15RL, 15RR) and the braking-force generating section (1) on the basis of whether the electric parking-brake mechanism (3RL, 3RR, 15RL, 15RR) has become in the abnormal state or not, whether the braking-force generating section (1) has become in the abnormal state or not, and whether the vehicle is moving or not.

\textcircled{16} The brake control apparatus as described in the item \textcircled{15}, wherein the braking-force generating section (1) is actuated without actuating the electric parking-brake mechanism (3RL, 3RR, 15RL, 15RR), in a case that the moving-state judging section (S204) determines that the vehicle is moving at the time of the switching manipulation. Accordingly, while the braking force desired by the driver can be obtained, the unstable state of the vehicle behavior can be suppressed to ensure the stability of the vehicle.

\textcircled{17} The brake control apparatus as described in the item \textcircled{15}, wherein the electric parking-brake mechanism (3RL, 3RR, 15RL, 15RR) is permitted to generate braking force, in a case that the electric parking-brake mechanism (3RL, 3RR, 15RL, 15RR) is required to be actuated by the switching manipulation when the moving-state judging section (S204) determines that the vehicle is moving and the braking-force-generating-section abnormal-state judging section (S614) determines that the braking-force generating section (1) is in the abnormal state. Accordingly, in the case that the braking-force generating section (1) is in the abnormal state, the actuation of the electric parking-brake mechanism (3RL, 3RR, 15RL, 15RR) is permitted even under the moving state of the vehicle, so that the vehicle can be decelerated.

\textcircled{18} The brake control apparatus as described in the item \textcircled{15}, wherein an actuation of the electric parking-brake mechanism (3RL, 3RR, 15RL, 15RR) continues to be restricted, and a desired braking-force value is calculated such that the braking force of the braking-force generating section (1) is maintained for a predetermined time duration and then is reduced when the predetermined time duration has elapsed, in a case that the moving-state judging section (S204) determines that the vehicle state has changed from a moving state to a stopped state when the parking-brake-mechanism abnormal-state judging section (S205) has determined that the electric parking-brake mechanism (3RL, 3RR, 15RL, 15RR) is in the abnormal state. Accordingly, the driver can have a time sufficient to depress the brake pedal. As a result, the unintentional downward movement of the vehicle can be suppressed when the vehicle is stopping on the sloping road.

\textcircled{19} The brake control apparatus as described in the item \textcircled{15}, wherein a desired braking-force value is reduced such that the braking force of the braking-force generating section (1) is reduced, and the electric parking-brake mechanism (3RL, 3RR, 15RL, 15RR) is permitted to generate braking force, when the moving-state judging section (S204) determines that the vehicle state has changed from a moving state to a stopped state. Accordingly, electric-power consumption can be suppressed as compared with the case that the stopped state of the vehicle is maintained only by the braking force of the braking-force generating section (1).

\textcircled{20} The brake control apparatus as described in the item \textcircled{15}, wherein an actuation of the braking-force generating section (1) is restricted when the braking-force-generating-section abnormal-state judging section (S614) determines that the braking-force generating section (1) is in the abnormal state, and wherein an actuation of the electric parking-brake mechanism (3RL, 3RR, 15RL, 15RR) is permitted when the electric parking-brake mechanism (3RL, 3RR, 15RL, 15RR) is required to be actuated by the switching manipulation in a case that the braking-force-generating-section abnormal-state judging section (S614) determines that braking-force generating section (1) is in the abnormal state and that the moving-state judging section (S204) determines that the vehicle is moving. Accordingly, if the braking-force generating section (1) is in the abnormal state, the actuation of the electric parking-brake mechanism (3RL, 3RR, 15RL, 15RR) is permitted even under the moving state of the vehicle, so that the vehicle can be decelerated.

This application is based on prior Japanese Patent Application No. 2011-257242 filed on Nov. 25, 2011. The entire contents of this Japanese Patent Application are hereby incorporated by reference.

The scope of the invention is defined with reference to the following claims.

What is claimed is:

1. A brake control apparatus comprising:
a parking-brake mechanism configured to apply braking force to left and right wheels of one of front and rear of a vehicle by a switching operation of a driver;
a braking-force generating section configured to apply braking force independently to the wheels in accordance with a state of the vehicle;
a moving-state judging section configured to judge whether or not the vehicle is moving; and
a braking-force control unit configured to control the braking-force generating section, the braking-force control unit including
a braking-force cooperative control section configured to restrict an actuation of the parking-brake mechanism and to cause the braking-force generating section to generate braking force in a case that the parking-brake mechanism is required to be actuated by the switching operation when the moving-state judging section determines that the vehicle is moving.

2. The brake control apparatus as claimed in claim 1, wherein
the braking-force control unit further includes a desired braking-force calculating section configured to calculate a desired braking-force value which should be generated by the braking-force generating section on the basis of a vehicle behavior, and
the braking-force cooperative control section is configured to actuate the braking-force generating section on the basis of the calculated desired braking-force value.

3. The brake control apparatus as claimed in claim 1, wherein
the brake control apparatus further comprises a parking-brake control unit configured to control the parking-brake mechanism,
the braking-force control unit further includes a desired braking-force calculating section configured to calculate a desired braking-force value which should be generated by the braking-force generating section, and
the braking-force control unit is configured to reduce the desired braking-force value such that the braking force of the braking-force generating section is reduced, and to permit the parking-brake control unit to actuate the parking-brake mechanism, when it is determined that the vehicle state has changed from a moving state to a stopped state.

4. The brake control apparatus as claimed in claim 3, wherein
the braking-force control unit is configured to reduce the braking force of the braking-force generating section after actuating the parking-brake mechanism.

5. The brake control apparatus as claimed in claim 4, wherein
the braking-force control unit is configured to reduce the braking force of the braking-force generating section at a predetermined gradient.

6. The brake control apparatus as claimed in claim 1, wherein
the brake control apparatus further comprises a parking-brake-mechanism abnormal-state judging section configured to judge whether or not the parking-brake mechanism is in an abnormal state, and
the braking-force control unit is configured to continue to restrict the actuation of the parking-brake mechanism and to calculate a desired braking-force value such that the braking force of the braking-force generating section is maintained for a predetermined time duration and then is reduced when the predetermined time duration has elapsed, in a case that the moving-state judging section determines that the vehicle state has changed from a moving state to a stopped state when the parking-brake-mechanism abnormal-state judging section has determined that the parking-brake mechanism is in the abnormal state.

7. The brake control apparatus as claimed in claim 1, wherein
the brake control apparatus further comprises a parking-brake control unit configured to control the parking-brake mechanism, and a braking-force-generating-section abnormal-state judging section configured to judge whether or not the braking-force generating section is in an abnormal state,
the braking-force control unit is configured to restrict an actuation of the braking-force generating section when the braking-force-generating-section abnormal-state judging section determines that the braking-force generating section is in the abnormal state, and
the parking-brake control unit is configured to permit the actuation of the parking-brake mechanism, when the parking-brake mechanism is required to be actuated by the switching operation in a case that the braking-force-generating-section abnormal-state judging section determines that braking-force generating section is in the abnormal state and that the moving-state judging section determines that the vehicle is moving.

8. A brake control apparatus comprising:
an electric parking-brake mechanism configured to apply braking force to rear left and right wheels of a vehicle by a switching operation of a driver;
a braking-force generating section configured to apply braking force independently to the wheels in accordance with a state of the vehicle;
a moving-state judging section configured to judge whether or not the vehicle is in a moving state;
an electric parking-brake control unit configured to control the electric parking-brake mechanism; and
a braking-force control unit configured to control the braking-force generating section,
wherein one of the electric parking-brake control unit and the braking-force control unit is configured to prohibit an actuation of the electric parking-brake mechanism in a case that the switching operation is conducted when the moving-state judging section determines that the vehicle is in the moving state.

9. The brake control apparatus as claimed in claim 8, wherein
the one of the electric parking-brake control unit and the braking-force control unit is the braking-force control unit.

10. The brake control apparatus as claimed in claim 9, wherein
the braking-force control unit includes a desired braking-force calculating section configured to calculate a desired braking-force value which should be generated by the braking-force generating section on the basis of a vehicle behavior, and
the braking-force control unit is configured to actuate the braking-force generating section on the basis of the calculated desired braking-force value.

11. The brake control apparatus as claimed in claim 10, wherein
the braking-force control unit is configured to reduce the desired braking-force value such that the braking force of the braking-force generating section is reduced, and to permit the electric parking-brake control unit to actuate the electric parking-brake mechanism, when it is determined that the vehicle state has changed from the moving state to a stopped state.

12. The brake control apparatus as claimed in claim 11, wherein
the braking-force control unit is configured to calculate the desired braking-force value to reduce the braking force of the braking-force generating section at a predetermined gradient after actuating the electric parking-brake mechanism.

13. The brake control apparatus as claimed in claim 12, wherein
the brake control apparatus further comprises a parking-brake-mechanism abnormal-state judging section configured to judge whether or not the electric parking-brake mechanism is in an abnormal state, and
the braking-force control unit is configured to continue to restrict the actuation of the electric parking-brake mechanism and to calculate the desired braking-force value such that the braking force of the braking-force generating section is maintained for a predetermined time duration and then is reduced when the predetermined time duration has elapsed, in a case that the moving-state judging section determines that the vehicle state has changed from the moving state to the stopped state when the parking-brake-mechanism abnormal-state judging section has determined that the electric parking-brake mechanism is in the abnormal state.

14. The brake control apparatus as claimed in claim 13, wherein
the brake control apparatus further comprises a braking-force-generating-section abnormal-state judging section configured to judge whether or not the braking-force generating section is in an abnormal state,
the braking-force control unit is configured to restrict the actuation of the braking-force generating section when the braking-force-generating-section abnormal-state judging section determines that the braking-force generating section is in the abnormal state, and
the parking-brake control unit is configured to permit the actuation of the electric parking-brake mechanism, when the electric parking-brake mechanism is required to be actuated by the switching operation in a case that the braking-force-generating-section abnormal-state judging section determines that braking-force generating section is in the abnormal state and that the moving-state judging section determines that the vehicle is in the moving state.

15. A brake control apparatus comprising:
an electric parking-brake mechanism configured to apply braking force to rear left and right wheels of a vehicle by a switching manipulation of a driver;
a braking-force generating section configured to apply braking force independently to the wheels in accordance with a state of the vehicle;
a parking-brake-mechanism abnormal-state judging section configured to judge whether or not the electric parking-brake mechanism is in an abnormal state;
a braking-force-generating-section abnormal-state judging section configured to judge whether or not the braking-force generating section is in an abnormal state; and
a moving-state judging section configured to judge whether or not the vehicle is moving;
wherein the electric parking-brake mechanism and the braking-force generating section are selectively actuated in accordance with judgment results of the parking-brake-mechanism abnormal-state judging section, the braking-force-generating-section abnormal-state judging section and the moving-state judging section at a time of the switching manipulation.

16. The brake control apparatus as claimed in claim 15, wherein
the braking-force generating section is actuated without actuating the electric parking-brake mechanism, in a case that the moving-state judging section determines that the vehicle is moving at the time of the switching manipulation.

17. The brake control apparatus as claimed in claim 15, wherein
the electric parking-brake mechanism is permitted to generate braking force, in a case that the electric parking-brake mechanism is required to be actuated by the switching manipulation when the moving-state judging section determines that the vehicle is moving and the braking-force-generating-section abnormal-state judging section determines that the braking-force generating section is in the abnormal state.

18. The brake control apparatus as claimed in claim 15, wherein
an actuation of the electric parking-brake mechanism continues to be restricted, and a desired braking-force value is calculated such that the braking force of the braking-force generating section is maintained for a predetermined time duration and then is reduced when the predetermined time duration has elapsed, in a case that the moving-state judging section determines that the vehicle state has changed from a moving state to a stopped state when the parking-brake-mechanism abnormal-state judging section has determined that the electric parking-brake mechanism is in the abnormal state.

19. The brake control apparatus as claimed in claim 15, wherein
a desired braking-force value is reduced such that the braking force of the braking-force generating section is reduced, and the electric parking-brake mechanism is permitted to generate braking force, when the moving-state judging section determines that the vehicle state has changed from a moving state to a stopped state.

20. The brake control apparatus as claimed in claim 15, wherein
an actuation of the braking-force generating section is restricted when the braking-force-generating-section abnormal-state judging section determines that the braking-force generating section is in the abnormal state, and
an actuation of the electric parking-brake mechanism is permitted, when the electric parking-brake mechanism is required to be actuated by the switching manipulation in a case that the braking-force-generating-section abnormal-state judging section determines that braking-force generating section is in the abnormal state and that the moving-state judging section determines that the vehicle is moving.
